(19) United States
(12) Patent Application Publication
(10) Pub. No.: US 2026/0235985 A1
(43) Pub. Date: Aug. 13, 2026

(54) IMAGE FORMING APPARATUS

(71) Applicant: KYOCERA Document Solutions Inc., Osaka (JP)

(72) Inventor: Yoshihito HARIBA, Osaka (JP)

(73) Assignee: KYOCERA Document Solutions Inc., Osaka (JP)

(21) Appl. No.: 19/531,174

(22) Filed: Feb. 5, 2026

(30) Foreign Application Priority Data
Feb. 7, 2025 (JP) 2025-019312

(51) Int. Cl. G03G 15/00; G03G 21/20

(52) U.S. Cl. CPC G03G 15/6573; G03G 15/6552; G03G 21/206; G03G 2215/00421

(57) ABSTRACT

An image forming apparatus comprises an imaging device, a fixing device, an ejecting device, and a roof section.

The imaging device forms a toner image on a medium.

The fixing device thermally fixes the toner image to the medium.

The ejecting device ejects the medium from an ejection port provided at an upper portion of the apparatus body toward an ejection tray.

The roof section is positioned above the ejecting device and formed as a cantilever beam facing the ejection tray across a space. The roof section comprises a diffusion suppression plate extending along a medium ejecting direction from the apparatus body above the ejection port, and a diffusion suppression rib protruding downward from a downstream end of the diffusion suppression plate in the ejecting direction and facing a part of the ejecting device at an interval.

### INCORPORATION BY REFERENCE

This application is based on and claims the benefit of priority from Japanese Patent application No. 2025-019312 filed on Feb. 7, 2025, the entire contents of which are incorporated herein by reference.

### BACKGROUND

The present disclosure relates to an image forming apparatus.

An image forming apparatus that forms an image on sheet using an electrophotographic method includes a fixing device that thermally fixes a toner image onto the sheet by pressuring and heating. When a toner (developer) on the sheet is heated and melted, volatile substances contained in the toner is volatilized and flowed out from an ejection port of the sheet to the outside of the housing, potentially causing an unpleasant odor. In order to reduce an outflow amount of volatile substances, various techniques have been proposed. For example, the known image forming apparatus includes an exhaust duct for discharging air near the fixing device to the outside of the housing, a suction member for drawing air near the fixing device and circulating it into the exhaust duct, and a first filtering section provided within the exhaust duct to carry a polar adsorbent that adsorbs polar substances (volatile substances).

However, the above mentioned image forming apparatus required the installation of a complex and specialized structure, namely the first filter section carrying the polar adsorbent, in order to adsorb polar substances (volatile substances). Consequently, in the above mentioned image forming apparatus, there are problems that miniaturization is impeded and manufacturing cost is increased.

### SUMMARY

An image forming apparatus in accordance with the present disclosure comprises an apparatus body, an imaging device, a fixing device, an ejecting device, and a roof section. The imaging device forms a toner image on a medium. The fixing device thermally fixes the toner image to the medium passing through a pressure region between a heating member and a pressuring member. The ejecting device ejects the medium that has passed through the pressure region from an ejection port provided at an upper portion of the apparatus body toward an ejection tray. The roof section is positioned above the ejecting device and formed as a cantilever beam facing the ejection tray across a space. The roof section comprises a diffusion suppression plate extending along an ejecting direction of the medium from the apparatus body above the ejection port, and a diffusion suppression rib protruding downward from a downstream end of the diffusion suppression plate in the ejecting direction and facing a part of the ejecting device at an interval.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an image forming apparatus in accordance with one embodiment of the present disclosure.

FIG. 2 is a cross-sectional view (side view) showing an internal structure of the image forming apparatus in accordance with one embodiment of the present disclosure.

FIG. 3 is a cross-sectional view (side view) showing an ejecting device, a roof section and a smoke misrecognition suppression structure in the image forming apparatus in accordance with one embodiment of the present disclosure.

FIG. 4 is a cross-sectional view along a line IV-IV of FIG. 3.

FIG. 5 is a cross-sectional view (side view) showing the roof section and others in the image forming apparatus in accordance with a modified example of one embodiment of the present disclosure.

### BRIEF DESCRIPTION OF THE INVENTION

The embodiments of the present disclosure will now be described with reference to the accompanying drawings. In the drawings, Fr, Rr, L, R, U, and D indicate a front side, a rear side, a left side, a right side, an up side, and a down side, respectively. Furthermore, front and rear directions (along an ejecting direction), left and right directions (a width direction), and up and down directions are mutually orthogonal. Although terms indicating direction or position are used herein, such terms are used for convenience of explanation and do not limit the technical scope of the present disclosure. Also, in each figure, shapes, dimensions, angles, and others of each component are not exact and are schematized for explanatory purposes.

### Image Forming Apparatus

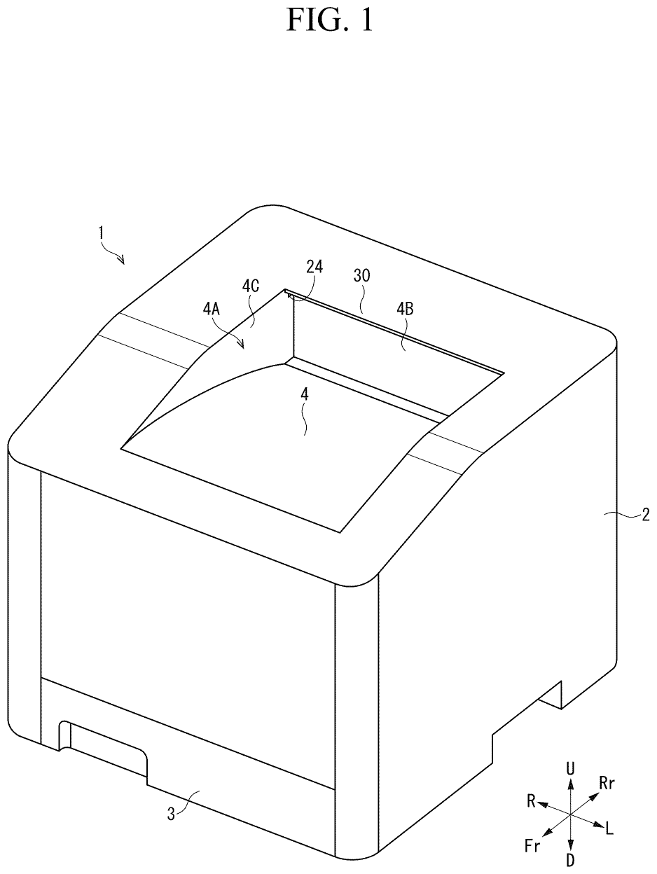

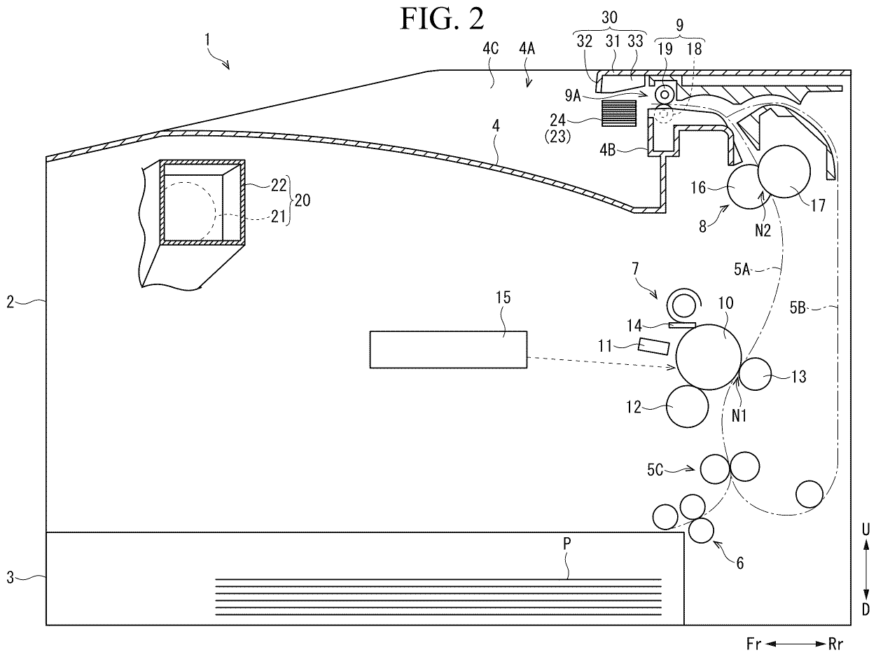

Referring to FIGS. 1 and 2, an image forming apparatus 1 will be described. FIG. 1 is a perspective view showing the image forming apparatus 1. FIG. 2 is a cross sectional view (side view) showing the internal structure of the image forming apparatus 1.

The image forming apparatus 1 is a printer that forms an image by transferring a toner image formed by the electrophotographic method onto a sheet P (medium). As shown in FIG. 1, the image forming apparatus 1 includes an apparatus body 2 having a substantially rectangular prism shaped exterior. At a lower portion of the apparatus body 2, for example, a supply cartridge 3 for holding the sheet P is detachably attached. At an upper portion of the apparatus body 2, an ejection tray 4 which serves as a discharge destination for the sheet P is provided. The apparatus body 2 includes a metal frame and a synthetic resin member fixed to this frame. Furthermore, the sheet P as an example of the medium is not limited to paper and may also be a resin sheet or the like.

A top surface of the apparatus body 2 slopes upward from a front end toward the center in the front and rear directions and is formed substantially horizontally from the center in the front and rear directions toward a rear end. The ejection tray 4 constitutes a bottom surface of the ejection recess 4A, which is deeply recessed in a central region of the top surface of the apparatus body 2. As shown in FIGS. 1 and 2, the ejection tray 4 curves from the front side of the top surface of the apparatus body 2 toward the rear side and slopes downward. The rear end of the ejection tray 4 is positioned at the rear side than the center of the top surface of the apparatus body 2 in the front and rear directions. Between the rear end of the ejection tray 4 and the rear portion of the top surface of the apparatus body 2, an ejection opening face 4B is formed. Between a left end of the ejection tray 4 and a left side of the top surface of the apparatus body 2, and between a right end of the ejection tray 4 and a right side of the top surface of the apparatus body 2, a pair of ejection side faces 4C are formed. The ejection opening face 4B and each ejection side face 4C are respectively upright faces constituting the ejection recess 4A. The ejection recess 4A (the ejection tray 4, the ejection opening face 4B, and each ejection side face 4C) constitutes a part of the apparatus body 2. At an upper portion of the ejection opening face 4B, an ejection port 9A (see FIG. 2) for ejecting the sheet P is formed. The ejection port 9A is an opening connecting the interior and exterior of the apparatus body 2, and is formed with a lateral width corresponding to the sheet P with the maximum size among image-formable sheets.

As shown in FIG. 2, inside the apparatus body 2, a conveyance path 5A used for conveying the sheet P from the supply cartridge 3 to the ejection tray 4 is formed. The conveyance path 5A is formed in a roughly S-shaped configuration extending from the rear lower portion to the rear upper portion of the apparatus body 2. At the rear portion of the apparatus body 2, an inverted conveyance path 5B branching off at a downstream side (an upper portion) of the conveyance path 5A and rejoining at an upstream side (a lower portion) of the conveyance path 5A is provided. At an upstream end of the conveyance path 5A (near the supply cartridge 3), a supply device 6 for supplying the sheet P stored in the supply cartridge 3 to the conveyance path 5A is provided. At a downstream than the supply device 6, to the conveyance path 5A, a pair of register rollers 5C that temporarily block the conveyed sheet P to correct its skew (skew correction) is provided.

As shown in FIG. 2, inside the apparatus body 2, an imaging device 7, a fixing device 8, an ejecting device 9, and a blowing device 20 are provided. The imaging device 7 is positioned at the downstream side than the supply device 6 in the conveyance path 5A to form a toner image on the conveyed sheet P. The fixing device 8 is positioned at the downstream side than the imaging device 7 in the conveyance path 5A to thermally fix the toner image onto the sheet P. The ejecting device 9 is positioned at the downstream side than the fixing device 8 in the conveyance path 5A to eject the sheet P from the ejection port 9A provided at the upper portion of the ejection opening face 4B (the apparatus body 2) to the ejection tray 4. The blowing device 20 cools a part of the imaging device 7 (details described later).

### Imaging Device

The imaging device 7 comprises a photosensitive drum 10, a charging device 11, a developing device 12, a transfer roller 13, a cleaning device 14, and an optical scanning device 15. The photosensitive drum 10 is formed in a cylindrical shape elongated in the left and right directions and rotates around its axis (counterclockwise in FIG. 2) driven by a motor (not shown). The charging device 11, the developing device 12, the transfer roller 13, and the cleaning device 14 are arranged around the photosensitive drum 10 in the order of the image forming process. The transfer roller 13 contacts the photosensitive drum 10 and forms a transfer region N1 between them. Although not shown, inside the apparatus body 2, a toner container containing a replenishment toner (developer) is detachably attached. The toner container is connected to the developing device 12 via a replenishment tube and supplies the toner to the developing device 12.

### Fixing Device

The fixing device 8 is positioned rearward and downward from the ejection port 9A. The fixing device 8 comprises a heating belt 16 (a heating member) and a pressuring roller 17 (a pressuring member). The heating belt 16 is made from a flexible material and formed in a substantially cylindrical shape extending in the left and right directions. The heating belt 16 is rotatably supported by a support member (not shown) extending through its axial direction (the left and right directions) and a pair of end holders (not shown) fitted to both axial ends. A heater (not shown) for heating the heating belt 16 is provided within the hollow portion of the heating belt 16. The heater may, for example, employ a halogen lamp, a heating substrate having a heating resistor or the like. The pressuring roller 17 as one example of a pressuring member is formed in a roughly cylindrical shape extending in the left and right directions by laminating an elastic layer or the like onto the outer peripheral surface of a shaft. The pressuring roller 17 is pressed against the heating belt 16 to form a pressure region N2 between the heating belt 16 and the pressuring roller 17. The pressuring roller 17 is driven by a motor (not shown) to rotate about its axis and the heating belt 16 rotates in response to the pressuring roller 17.

### Ejecting Device

The ejecting device 9 is located inside the apparatus body 2 near the ejection port 9A. The ejecting device 9 comprises an ejection drive roller 18 and an ejection following roller 19. The ejection drive roller 18 and the ejection following roller 19 respectively have a plurality of rollers arranged at intervals in the left and right directions. The plurality of rollers are arranged to accommodate respective sizes (lateral widths) of various image-formable sheets P. Each roller is fixed to a shaft to rotate about the shaft. The ejection following roller 19 (roller) contacts an upper portion of the ejection drive roller 18 (roller). The ejection drive roller 18 is driven by a motor (not shown) to rotate about its axis, and the ejection following roller 19 in response to the ejection drive roller 18.

### Blowing Device

The blowing device 20 comprises a blowing fan 21 and a blowing duct 22. The blowing fan 21 is provided, for example, at a front upper portion of the apparatus body 2. The blowing fan 21 is, for example, an axial fan that generates an airflow from one side to another side in an axial direction by rotating blades around an axis. The blowing duct 22 is a conduit connecting the blowing fan 21 to a part of the imaging device 7 and others. Although detailed illustration is omitted, the blowing duct 22 is piped, for example, to supply cooling air to the photosensitive drum 10, the developing device 12, the voltage board (not shown) controlling the power supplied to each component, and others. The airflow generated by the blowing fan 21 is supplied to the photosensitive drum 10 and others through the blowing duct 22 to cool the photosensitive drum 10 and others. Incidentally, in FIG. 2, only a part of the blowing fan 21 is illustrated.

The blowing fan 21 is not limited to the axial fan, it may be another type fan, such as a centrifugal fan or a sirocco fan. Furthermore, while, as one example, the blowing device 20 may cool the photosensitive drum 10, the developing device 12 and the voltage board, the present disclosure is not limited thereto. The blowing device 20 20 may cool at least a part of the imaging device 7, or may cool all components of the imaging device 7, or may cool other components (e.g., the fixing device 8 or the like) in addition to the imaging device 7.

### Image Formation Process

Here, the operation of the image forming apparatus 1 is described. A controlling device (not shown) that integrally controls the image forming apparatus 1 executes image forming processing (control), for example, based on image data inputted from an external terminal, as follows.

The charging device 11 the surface of the photosensitive drum 10. The optical scanning device 15 emits scanning light toward the photosensitive drum 10 to form an electrostatic latent image corresponding to the image data on the surface of the photosensitive drum 10. The developing device 12 develops the develops the electrostatic latent image on the photosensitive drum 10 into the toner image using the toner supplied from the toner container. The supply device 6 picks up the sheet P within the supply cartridge 3 one by one and supplies it into the conveyance path 5A. The sheet P is conveyed along the conveyance path 5A and undergoes skew correction by the pair of register rollers 5C. The transfer roller 13 transfers the toner image on the photosensitive drum 10 onto the surface of the sheet P passing through the transfer region N1. Subsequently, the cleaning device 14 removes any remaining toner from the photosensitive drum 10. The fixing device 8 thermally fixes the toner image onto the sheet P passing through the pressure region N2 between the heating belt 16 and the pressure roller 17 (fixing operation). For single-sided printing, the ejecting device 9 ejects the sheet P that has passed through the pressure region N2 from the ejection port 9A toward the ejection tray 4.

For duplex printing, the sheet P passing through the fixing device 8 is sent to the inverted conveyance path 5B by switching-back at the downstream side in the conveyance path 5A. The sheet P is returned from the inverted conveyance path 5B to the conveyance path 5A again, undergoes skew correction by the pair of register rollers 5C, and is then sent to the transfer region N1. Subsequently, the toner image is transferred onto the sheet P, thermally fixed, and the double-sided printed sheet P is ejected to the ejection tray 4.

### Problems Caused by Volatile Substances

However, when the toner (developer) on the sheet P is heated and melted, volatile substances contained in the toner may volatilize and flow out to the outside through the ejection port 9A of the sheet P, potentially causing an unpleasant odor. Therefore, it is desirable to reduce the outflow amount of the volatile substances. The volatile substances contain fine particles with diameters of 0.1 μm or less and have the characteristic that multiple fine particles tend to combine over time. Therefore, the number of particles of the volatile substance can be reduced by extending the distance from the ejection port 9A to the outside air and increasing the time required for diffusion into the outside air. Accordingly, in order to reduce the outflow amount of the volatile substances, the image forming apparatus 1 of the embodiment includes a roof portion 30 that extends the distance (travel distance (or travel time) of the volatile substances (the fine particles)) from generation point (the pressure region N2) of the volatile substances (the fine particles) to a point where they can diffuse into the outside.

### Roof Section

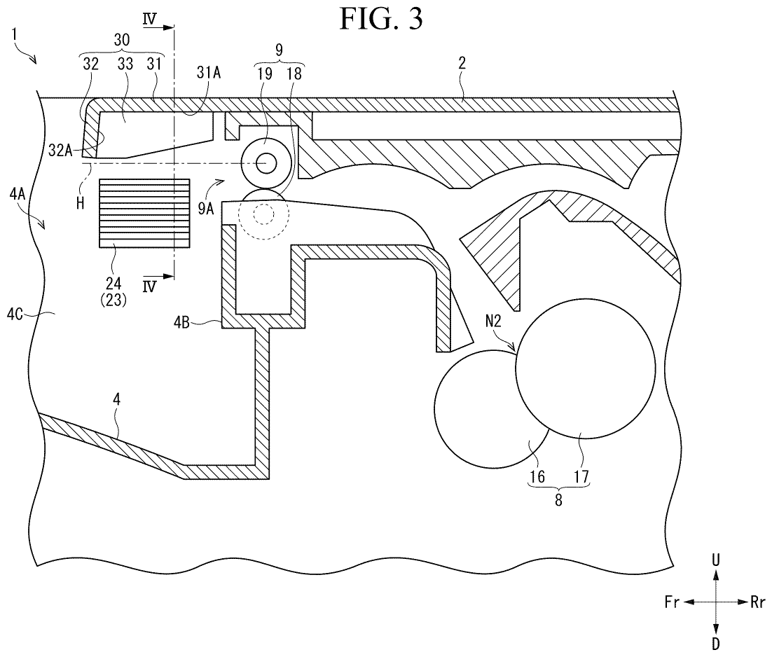

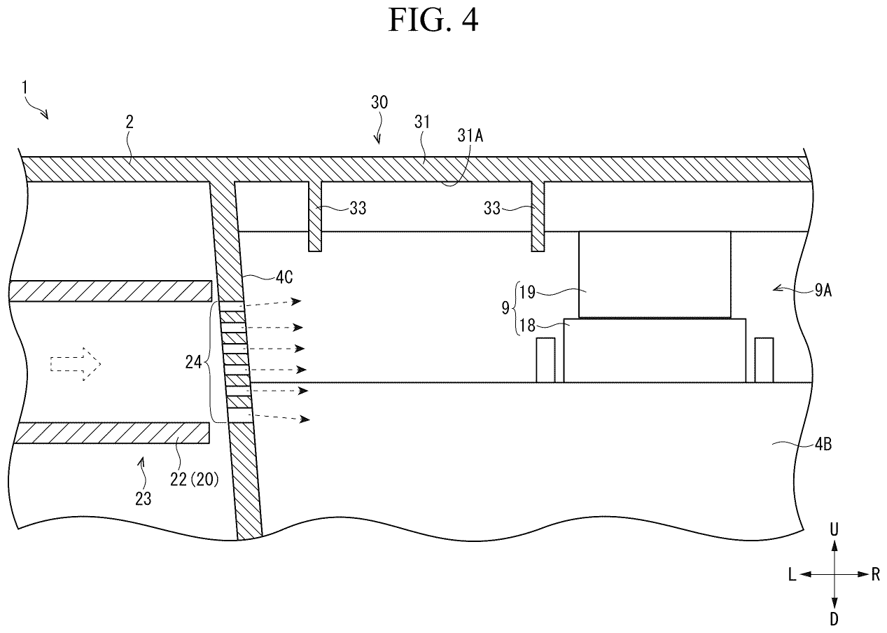

Referring to FIGS. 2 to 4, the roof section 30 will be described. FIG. 3 is a cross-sectional view (side view) showing the ejecting device 9, the roof section 30 and others. FIG. 4 is a cross-sectional view along a line IV-IV of FIG. 3.

As shown in FIGS. 2 and 3, the roof section 30 is positioned above the ejecting device 9 and is formed as a cantilever beam facing the ejection tray 9 across a space. The roof section 30 includes a diffusion suppression plate 31, a diffusion suppression rib 32, and a plurality of guide ribs 33.

### Diffusion Suppression Plate

As shown in FIG. 3, the diffusion suppression plate 31 extends forward (along the ejecting direction of the sheet P) from the apparatus body 2 at a position above the ejection port 9A. Specifically, the diffusion suppression plate 31 extends forward from an upper edge of the ejection opening surface 4B. More specifically, the diffusion suppression plate 31 is formed as a substantially flat plate integrated with a rear potion of an upper surface of the apparatus body 2 and is provided so as to span a rear end portion of the ejection recess 4A with a roof (see also FIG. 1). Furthermore, the diffusion suppression plate 31 is mounted between a pair of left and right ejection side faces 4C.

### Diffusion Suppression Rib

The diffusion suppression rib 32 protrudes downward from a front end (a downstream end in the ejecting direction) of the diffusion suppression plate 31. The diffusion suppression plate 31 and the diffusion suppression rib 32 is formed with a substantially L-shaped cross-section. Furthermore, the diffusion suppression rib 32 faces a part (an upper portion) of the ejecting device 9 (or the ejection port 9A) at an interval. For example, a gap (distance) between a rear face 32A of the diffusion suppression rib 32 and the ejection opening face 4B (a face forming the ejection port 9A) is set to approximately 25 mm. Furthermore, the diffusion suppression rib 32 faces an upper portion of the ejection following roller 19 above a contact position of the ejection drive roller 18 and the ejection following roller 19. Specifically, a lower end of the diffusion suppression rib 32 is positioned at a height of a horizontal line H, that passes through the rotational center of the ejection following roller 19, or higher. Incidentally, in FIG. 3, the lower end of the diffusion suppression rib 32 is positioned at the height above the horizontal line H, but this is not limited thereto; it may also coincide with the horizontal line H (not shown).

### Guide Rib

As shown in FIGS. 3 and 4, each guide rib 33 protrudes downward from a top face 31A of the diffusion suppression plate 31, extends in the front and rear directions (a direction along the ejecting direction), and guides the sheet P ejected from the ejection port 9A. The plurality of guide ribs 33 are arranged at predetermined intervals in the left and right directions (the width direction) (see FIG. 4). The plurality of guide ribs 33 are arranged ribs 33 are arranged to accommodate respective sizes (widths) of various image-formable sheets P. Viewed from the lateral side, each guide rib 33 is formed in a substantially pentagonal shaped plate having a lower edge inclined upward from the front side to the rear side (see FIG. 3). Each guide rib 33 is connected to the top face 31A of the diffusion suppression plate 31 and the rear face 32A (an inner surface) of the diffusion suppression rib 32 (see FIG. 3).

### Function of Roof Section

The function of the roof section 30 described above will be explained. The roof section 30 extends the travel distance (the travel time) from the fixing device 8, where the volatile substances are generated, to a position where the volatile substances can diffuse into the outside air.

When the toner on the sheet P is heated and melted by the fixing device 8, the volatile substances (the fine particles) are generated from the toner. The volatile substances flow out of the apparatus body 2 from the ejection port 9A through the conveyance path 5A. The heated volatile substances (the fine particles) are lighter than the outside air and therefore tend to move upward after flowing out of the ejection port 9A. However, the roof section 30 (the diffusion suppression plate 31) is provided in front of the ejection port 9A (the downstream side in the ejecting direction). Consequently, the volatile substances (the fine particles) cannot move upward and instead move further forward (to the downstream side in the ejecting direction) along the top face 31A of the diffusion suppression plate 31. In other words, the travel distance of the volatile substances (the fine particles) is extended by the length of the diffusion suppression plate 31 in the front and rear directions, and consequently, the travel time is also extended.

Furthermore, since the diffusion suppression rib 32 protrudes downward from the front end of the diffusion suppression plate 31, the volatile substances moving along the top face 31A of the diffusion suppression plate 31 collide with the diffusion suppression rib 32 and diffuse into the outside air through the space below the diffusion suppression rib 32. In other words, the travel distance of the volatile substances (the fine particles) is extended by a length required to avoid the diffusion suppression rib 32, and consequently, the travel time is also extended.

Multiple fine particles contained within the volatile substances combine during their movement from generation point to a point where they can diffuse into the outside, thereby reducing the number of particles. As described above, the roof portion 30 extends the travel distance (the travel time) of the volatile substances by the roof portion 30. This provides sufficient time for combining the multiple fine particles, effectively reducing the number of particles of the volatile substances.

In the image forming apparatus 1 according to the present embodiment described above, the roof portion 30 is formed as a cantilever beam extending forward (along the ejecting direction) above the ejecting device 9. According to such configuration, the fine particles of the volatile substances flow out from the ejection port 9A and tend to move upward, but the roof portion 30 (primarily the diffusion suppression plate 31) can restrict the upward movement of the volatile substances. The volatile substances are not diffused into the outside air unless they pass below the roof section 30. Therefore, compared to a configuration without the roof section 30, the travel distance (or the travel time) required for diffusion of the volatile substances into the outside air can be extended. Furthermore, since the diffusion suppression rib 32 protrudes downward from the front end of the diffusion suppression plate 31, compared to when the diffusion suppression rib 32 is absent, the volatile substances become more difficult to diffuse into the outside air, allowing the travel distance (or the travel time) until such diffusion occurs to be allowing the movement time (or travel time) until such diffusion occurs to be further extended. Multiple fine particles contained within the volatile substances combine while passing below the roof section 30. Therefore, extending the travel distance (or the travel time) associated with the diffusion of the volatile substances can reduce the number of particles of the volatile substances. This allows the outflow amount of the volatile substances to be reduced through the simple structure of providing the roof section 30, without requiring complex or specialized structures. Furthermore, because such structure is simple, it enables miniaturization of the image forming apparatus 1 and reduces its manufacturing cost of the image forming apparatus 1.

In the image forming apparatus 1 according to the present embodiment, each guide rib 33 is protruded downward from the top face 31A of the diffusion suppression plate 31. Such configuration allows the sheet P ejected from the ejection port 9A to be ejected toward the ejection tray 4 without colliding with the diffusion suppression rib 32. This suppresses ejection failures of the sheet P, such as jamming of the sheet P around the ejection port 9A. In the image forming apparatus 1 according to the present embodiment, the plurality of guide ribs 33 are provided; however, this is not limited thereto, and it is sufficient to provide one or more guide ribs 33.

### Problems Caused by Water Vapor

When the sheet P containing a high amount of moisture (high moisture content) is used for imaging, water vapor may be generated from the sheet P during thermal fixing in the fixing device 8. The water vapor generated from the sheet P flows out through the ejection port 9A, similar to the volatile substances. When the water vapor flows out from the ejection port 9A, the user may mistakenly perceive it as the user may mistakenly perceive it as smoke. Therefore, the image forming apparatus 1 according to the present embodiment is provided with a smoke misrecognition suppression structure 23 that suppresses misrecognition of water vapor flowing out from the ejection port 9A as smoke.

### Smoke Misrecognition Suppression Structure

Referring to FIGS. 2 to 4, the smoke misrecognition suppression structure 23 will be described. The smoke misrecognition suppression structure 23 includes a blowing port 24 and a blowing device 20. Incidentally, the blowing device 20 is a component for cooling a part of the imaging device 7, but it is also an element constituting the smoke misrecognition suppression structure 23.

The blowing port 24 is provided at an upper portion of the ejection side face 4C, which is at the left side of the ejection recess 4A. Viewed from the lateral side, the blowing port 24 is positioned below the lower end of the diffusion suppression rib 32 of the roof section 30 and also behind the rear face 32A of the diffusion suppression rib 32 (see FIG. 3). The blowing port 24 is formed by arranging multiple slits in the up and down directions extending in the front and rear directions. The blowing port 24 is positioned to face a downstream end of the blowing duct 22 (see FIG. 4). Although the blowing port 24 is shown provided on the left ejection side face 4C, it is not limited thereto and may also be provided on the right ejection side face 4C (not shown).

### Function of Smoke Misrecognition Suppression Structure

The function of the smoke misrecognition suppression structure 23 described above will be explained. When the blowing fan 21 of the blowing device 20 rotates, an airflow is generated within the blowing duct 22. The airflow generated by the blowing fan 21 cools components such as the photosensitive drum 10 while flowing through the blowing duct 22 and is discharged from the blowing port 24 (refer to dashed arrow in FIG. 4). The airflow (air) discharged from the blowing port 24 flows from the left side to the right side along the top face 31A of the diffusion suppression plate 31, cooling the water vapor flowing out from the ejection port 9A. This causes the water vapor to change state back to water, thereby suppressing the user's visual perception of the water vapor.

In the image forming apparatus 1 according to the present embodiment described above, the blowing device 20, which cools a part of the imaging device 7, generates an airflow flowing from the left side to the right side (from one side to another side in the width direction orthogonal to the ejecting direction) along the top face 31A of the diffusion suppression plate 31. According to such configuration, the water vapor flowing out from the ejection port 9A can be cooled by the airflow, promoting its phase change to water. This reduces the user's opportunity to visually perceive the water vapor, thereby suppressing misrecognition of smoke by the user. Furthermore, the roof section 30, which delays the diffusion of the volatile substances, can also serve as an air passage through which the airflow circulates. This can reduce the outflow of both volatile substances and water vapor by a simpler structure, compared to separately providing the roof section 30 and the air passage.

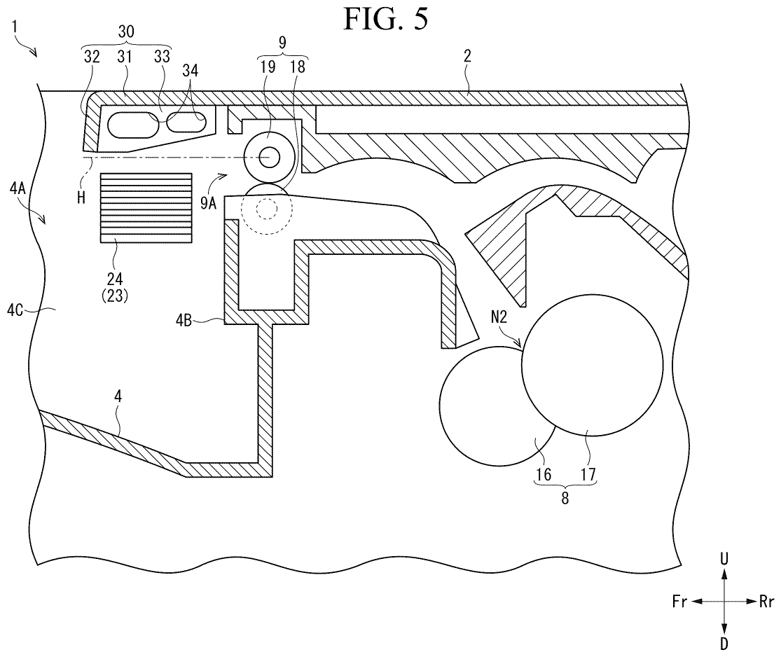

In the image forming apparatus 1 according to the present embodiment, since each guide rib 33 protrudes downward from the top face 31A of the diffusion suppression plate 31, it may obstruct the airflow discharged from the blowing port 24. Therefore, as shown in FIG. 5, each guide rib 33 may be formed with a flowing hole 34 that allows the airflow moving from the left side to the right side to pass through (a modified example). With such configuration, since the flowing hole 34 for passing the airflow toward the guide ribs 33 is formed, the guide ribs 33 do not obstruct the air passage, allowing the roof section 30 to be effectively utilized as the air passage. Incidentally, in FIG. 5, as one example, two flowing holes 34 in a roughly elliptical shape are formed, but the number, shape, size and others of the flowing holes 34 may be freely changed. Furthermore, the flowing holes 34 may be formed in all guide ribs 33 or only in some guide ribs 33.

In the image forming apparatus 1 according to the present embodiment, the flowing device 20 is adopted as a part of the smoke misrecognition suppression structure 23, but the present disclosure is not limited thereto. The smoke misrecognition suppression structure 23 (the flowing port 24) may be omitted, and the flowing device 20 may be used solely for cooling the imaging device 7 (not shown).

Furthermore, the image forming apparatus 1 according to the present embodiment is so called printer, but it is not limited thereto and may also be a copying machine, a facsimile, a multifunction peripheral, or the like.

The description of the above embodiment illustrates one aspect of the image forming apparatus according to the present disclosure, and the scope of the present disclosure is not limited to the above embodiment. The present disclosure may be variously modified, substituted, or transformed without departing from the spirit of the technical concept, and the claims encompass all embodiments that may fall within the scope of the technical concept.

1. An image forming apparatus comprising:
an apparatus body;
an imaging device for forming a toner image on a medium;
a fixing device for thermally fixing the toner image to the medium passing through a pressure region between a heating member and a pressuring member;
an ejecting device for ejecting the medium that has passed through the pressure region from an ejection port provided at an upper portion of the apparatus body toward an ejection tray; and
a roof section positioned above the ejecting device and formed as a cantilever beam facing the ejection tray across a space;
wherein the roof section comprises:
a diffusion suppression plate extending along an ejecting direction of the medium from the apparatus body above the ejection port; and
a diffusion suppression rib protruding downward from a downstream end of the diffusion suppression plate in the ejecting direction and facing a part of the ejecting device at an interval.

2. The image forming apparatus according to claim 1, wherein
the ejecting device comprises an ejection drive roller and an ejection following roller,
a lower end of the diffusion suppression rib is positioned at a height of a horizontal line, that passes through a rotational center of the ejection following roller, or higher.

3. The image forming apparatus according to claim 1 further comprising:
a blowing device for cooling at least a part of the imaging device,
wherein the blowing device generates an airflow flowing from one side to another side in a width direction orthogonal to the ejecting direction along a top face of the diffusion suppression plate.

4. The image forming apparatus according to claim 1, wherein
the roof section is provided with a guide rib that protrudes downward from the top face of the diffusion suppression plate, extends in a direction along the ejecting direction, and guides the medium ejected from the ejection port.

5. The image forming apparatus according to claim 3, wherein
the roof section is provided with a guide rib that protrudes downward from the top face of the diffusion suppression plate, extends in a direction along the ejecting direction, and guides the medium ejected from the ejection port, and
the guide rib has a flowing hole formed so as to allow the airflow moving from one side to another side in the width direction to pass through.
